(19) United States
(12) Patent Application Publication
(10) Pub. No.: US 2011/0148556 A1
(43) Pub. Date: Jun. 23, 2011

(54) POWER QUALITY IMPROVEMENT DEVICE AND POWER SUPPLY SYSTEM

(76) Inventor: Hoon-Yang Park, Bucheon-si (KR)

(21) Appl. No.: 13/060,056

(22) PCT Filed: Sep. 16, 2009
(86) PCT No.: PCT/KR2009/005269

§ 371 Date: Feb. 21, 2011

(51) Int. Cl. H01F 30/12

(52) U.S. Cl. 336/12

(57) ABSTRACT

The present invention relates to a power quality improvement device. The power quality improvement device is provided in the form of an autotransformer which comprises an iron core having first, second and third legs, and first, second and third coils which are wound in a zigzag fashion around said first, second and third legs. At least two coils selected from the group that includes said first, second and third coils, alternatively wound around each of said first, second and third legs, are over-lappingly wound around the core in a winding sequence.

### TECHNICAL FIELD

The present invention relate to a power quality improvement device that can remove harmonics and unbalanced current more efficiently, and a power supply system including the same.

### BACKGROUND ART

Harmonics and unbalanced current are generated in an electric power system due to an increase in a non-linear load along with the development of power semiconductors. Such harmonics and unbalanced current are inputted to a power supply of low impedance, which leads to several problems including overheating of cables, an increase in power loss due to magnetic saturation of transformer cores, erroneous operation of electric devices, etc.

Therefore, a variety of methods for reducing harmonics and unbalanced current are used.

### DISCLOSURE OF INVENTION

### Technical Problem

Accordingly, the present invention has been made in order to satisfy the above-mentioned necessities, and it is an object of the present invention to provide a power quality improvement device that can remove harmonics and unbalanced current more efficiently and increase productivity.

Another object of the present invention is to provide a power supply system that can remove harmonics and unbalanced current more efficiently and increase productivity.

The objects of the present invention are not limited to the above objects, and other objects which are not disclosed will be appreciated from the following detailed description by those skilled in the art.

### Technical Solution

To achieve the above objects, in one aspect of a power quality improvement device according to one embodiment of the present invention, the power quality improvement device is provided in the form of an autotransformer and includes: an iron core including a first leg, a second leg, and a third leg; and a coil including a first winding, a second winding, and a third winding, which are wound in a zig-zag fashion around the first leg, the second leg and the third leg, wherein at least two windings selected from the group consisting of the first, second and third windings are wound alternately around each of the first, second and third legs of the coil in such a fashion as to be wound overlappingly around the core in the winding order.

In another aspect of a power quality improvement device according to one embodiment of the present invention, the power quality improvement device is provided in the form of an autotransformer and includes: an iron core including a first leg, a second leg, and a third leg; and a coil including a first winding, a second winding, and a third winding, wherein the first winding is wound around the first leg and the third leg in the order of the first leg, the third leg, the first leg, the third leg and the first leg so as to be connected to a neutral wire, the second winding is wound around the second leg and the first leg in the order of the second leg, the first leg, the second leg, the first leg and the second leg so as to be connected to the neutral wire, and the third winding is wound around the third leg and the second leg in the order of the third leg, the second leg, the third leg, the second leg and the third leg so as to be connected to the neutral wire, whereby the first winding, the second winding, the first winding, the second winding and the first winding are sequentially wound in an overlapping manner around the first leg, the second winding, the third winding, the second winding, the third winding and the second winding are sequentially wound in an overlapping manner around the second leg, and the third winding, the first winding, the third winding, the first winding and the third winding are sequentially wound in an overlapping manner around the third leg.

In one aspect of a power supply system according ₜo another embodiment of the present invention, the power supply system includes the power quality improvement device according to any one of claims 1 to 11, wherein the power quality improvement device is connected in series between a load and a power supply for supplying power to the load.

In another aspect of a power supply system according to another embodiment of the present invention, the power supply system includes: a load; a power supply for supplying power to the load; a power quality improvement device connected in series between the load and the power supply and provided in the form of an autotransformer, wherein the power quality improvement device includes: an iron core comprising a first leg, a second leg, and a third leg; and a coil comprising a first winding, a second winding, and a third winding, and wherein the first winding is wound around the first leg and the third leg in the order of the first leg, the third leg, the first leg, the third leg and the first leg so as to be connected to a neutral wire, the second winding is wound around the second leg and the first leg in the order of the second leg, the first leg, the second leg, the first leg and the second leg so as to be connected to the neutral wire, and the third winding is wound around the third leg and the second leg in the order of the third leg, the second leg, the third leg, the second leg and the third leg so as to be connected to the neutral wire.

Concrete contents of other embodiments are included in the following detailed description and accompanying drawings.

A power quality improvement device of the power supply system according to embodiments of the present invention is connected in series between a load and a power supply. Thus, the power quality improvement device can be disposed in maximally close proximity to the load to obtain high harmonics reduction effect. In addition, if the power supply system includes a plurality of load terminals, it has an effect in that since only one power quality improvement device is installed between a power receiving terminal and a power distribution terminal, the manufacturing cost is saved and productivity is improved. In the meantime, the power quality improvement device is installed between the power receiving terminal and the power distribution terminal, where there is a relatively much utilizable space, so that the space can utilized efficiently and installation is easy.

In addition, since the power quality improvement device according to the embodiments of the present invention is implemented in a more efficient structure and method, it is considerably excellent in both a harmonics reduction function and a current unbalance cancellation function. More specifically, the power quality improvement device according to the embodiments of the present invention has a structure in which since a plurality of windings is wound overlappingly around each of the first, second and third legs, the volume of the transformer can be greatly reduced. Further, the zig-zag winding method is easily performed, and thus, the time and cost in the manufacture process can be greatly saved, resulting in an increase in a manufacturing cost saving effect. Besides, since the windings are wound efficiently at less volume, the efficiency of the autotransformer constituting the power quality improvement device increases. That is, since the transformer is implemented in a more efficient structure and method, it is possible to provide a power quality improvement device, which is considerably excellent in both a harmonics reduction function and a current unbalance cancellation function.

### BRIEF DESCRIPTION OF THE DRAWINGS

FIG. 1 is a schematic block diagram illustrating a power supply system according to one embodiment of the present invention.

FIG. 2 is a schematic block diagram illustrating a power supply system according to another embodiment of the present invention.

FIG. 3 is a conceptual view illustrating a power quality improvement device according to one embodiment of the present invention.

FIG. 4 is a perspective view illustrating a power quality improvement device according to one embodiment of the present invention.

FIG. 5 is a top plan view of the power quality improvement device shown in FIG. 4.

FIG. 6 is a conceptual view illustrating a power quality improvement device according to another embodiment of the present invention.

FIG. 7 is a perspective view illustrating a power quality improvement device according to another embodiment of the present invention.

FIG. 8 is a top plan view of the power quality improvement device shown in FIG. 7.

### EXPLANATION ON REFERENCE NUMERALS OF MAIN ELEMENTS OF THE DRAWINGS

1, 2: power supply system

10, 12: power quality improvement device

110: core 200, 202: coil

### BEST MODE FOR CARRYING OUT THE INVENTION

The features, advantages, and methods of accomplishing the same of the present invention will be apparent from the following detailed description of the preferred embodiments of the invention in conjunction with the accompanying drawings. The present invention is not limited to the embodiments disclosed herein, but may be implemented in various different forms. These embodiments are provided to make the disclosure of the present invention complete and fully inform the scope of the present invention to a person of ordinary skill in the art to which the present invention pertains. The present invention should be defined by the technical scope of the appended claims. Throughout the specification, it is noted that the same reference numerals are used to designate the same constituent elements having the same function.

The terminology herein is merely used to describe specific embodiments of the present invention, but is not intended to limit the present invention. It should be noted that, in this specification and the appended claims, the singular forms, “a,” “an,” or “the”, includes plural referents unless the context clearly dictates otherwise.

It should be appreciated that the terms “comprise(s)”, “comprising”, “include(s)”, and “including”, or “have(has)” when used in this specification and in the following claims are intended to specify the presence of stated features, integers, steps, acts, elements, components or combination thereof, but they do not preclude the presence or addition of one or more other features, integers, steps, acts, elements, components or combination thereof

Now, preferred embodiments of the present invention will be described hereinafter in detail with reference to the accompanying drawings.

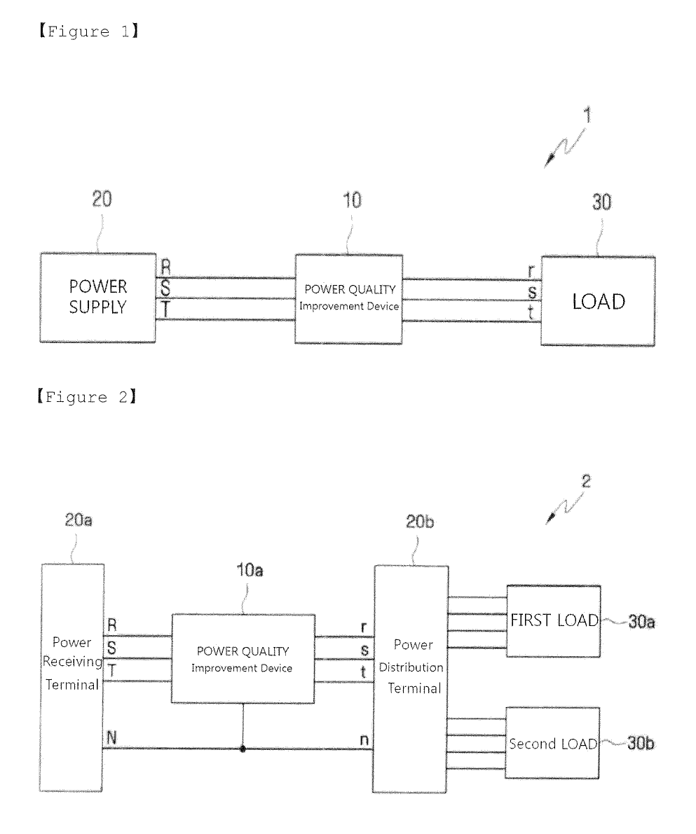

FIG. 1 is a schematic block diagram illustrating a power supply system according to one embodiment of the present invention.

Referring to FIG. 1, a power supply system 1 according to one embodiment of the present invention includes a power quality improvement device 10. The power quality improvement device 10 is connected in series between a power supply 12 outputting three-phase power supplied from a power plant along a power transmission line and a load 30.

The power quality improvement device 10 of the power supply system 1 according to one embodiment of the present invention reduces harmonics and cancels voltage (or current) unbalance caused by the load 30. In addition, the power quality improvement device 10 of the power supply system 1 according to one embodiment of the present invention is connected in series between the power supply 12 and the load 30. Thus, the power quality improvement device can be disposed in maximally close proximity to the load to obtain high harmonics reduction effect.

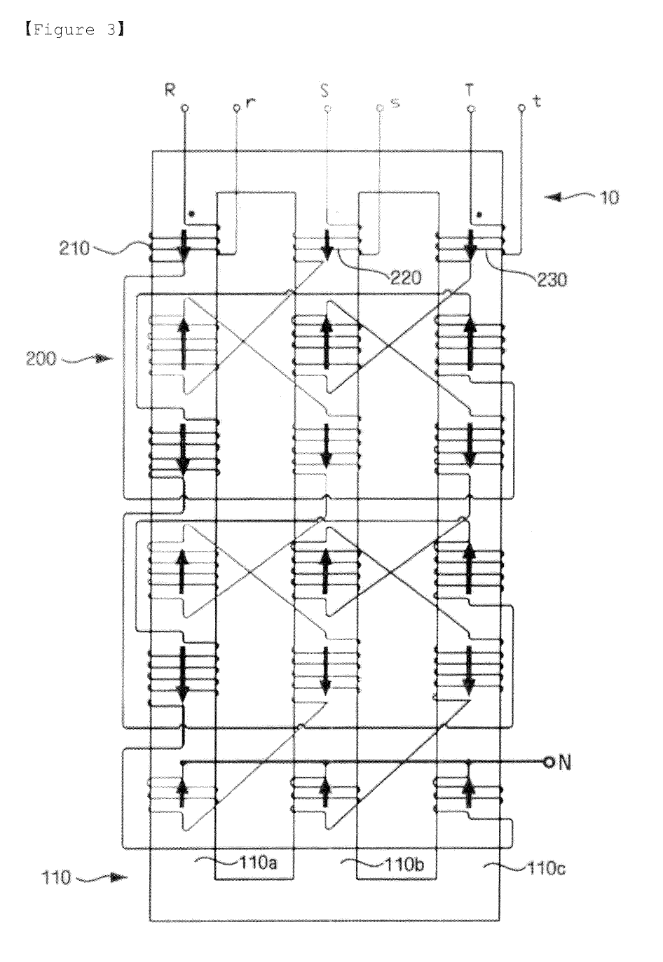

FIG. 2 is a schematic block diagram illustrating a power supply system according to another embodiment of the present invention.

Referring to FIG. 2, a power supply system 2 according to one embodiment of the present invention includes a power quality improvement device 10a. The power quality improvement device 10a is connected in series between a power receiving terminal 20a for receiving three-phase power supplied from a power supply (not shown) and a power distribution terminal 20b for distributing the three-phase power to a first load 30a and a second load 30b.

The power quality improvement device 10a of the power supply system 2 according to another embodiment of the present invention reduces harmonics by itself and cancels voltage (or current) unbalance caused by a facility of a power distribution system or the first load 30a and the second load 30. In the meantime, in the power supply system 2 according to another embodiment of the present invention, only one power quality improvement device 10a can be installed in the power supply system 2 including a plurality of load terminals 30a and 30b. That is, since a power quality improvement device 10a does not need to be separately installed in each load terminal, the manufacturing cost is saved and productivity is improved. Meanwhile, the power quality improvement device 10a is installed between the power receiving terminal 20a and the power distribution terminal 20b, where there is a relatively much utilizable space, so that the space can utilized efficiently and installation is easy.

The concrete construction of the power quality improvement devices 10 and 10a included in the power supply systems 1 and 2 according to embodiments of the present invention will described later. It is be of course to noted that although the power quality improvement device will be described hereinafter with it specified by reference numeral 10, all the power quality improvement devices 10 which will be described later can be applied to the power supply systems 1 and 2 according to embodiments of the present invention.

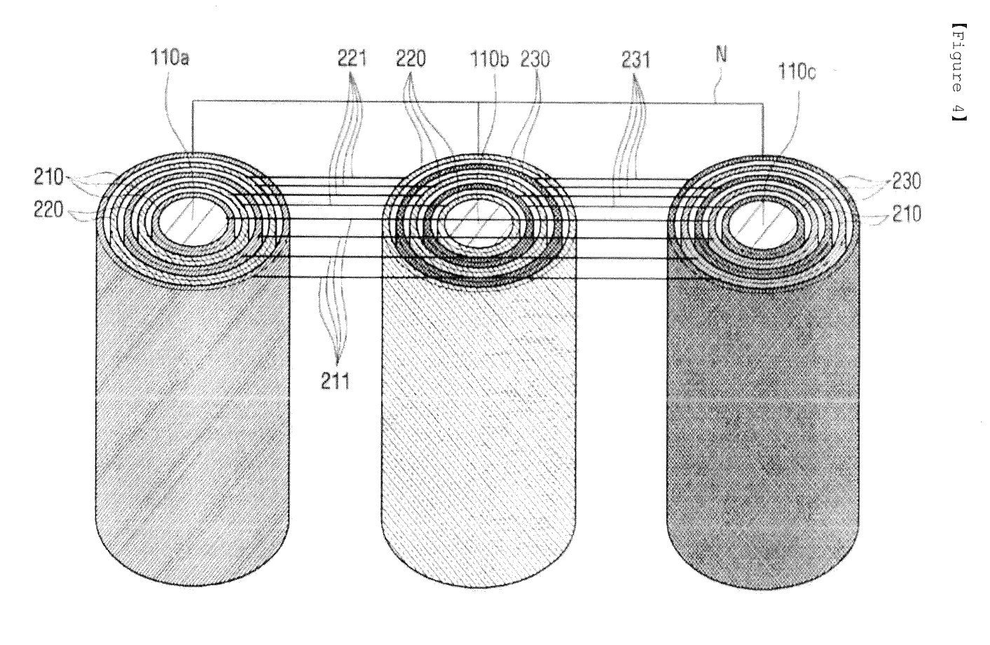

The power quality improvement device according to one embodiment of the present invention will be described in more detail with reference to FIGS. 3 to 5.

FIG. 3 is a conceptual view illustrating a power quality improvement device according to one embodiment of the present invention.

First, referring to FIG. 3, the power quality improvement device 10 according to one embodiment of the present invention includes an iron core 10 and a coil 200.

Herein, the power quality improvement device 10 according to one embodiment of the present invention may be an autotransformer, specifically a zigzag autotransformer.

The core 110 includes a first leg 110a, a second leg 110b, and a third leg 110c. The first leg 110a, the second leg 110b, and the third leg 110c can be arranged juxtaposedly as shown in FIG. 3. The core 110 may use a silicon steel plate. Alternatively, the core 110 may use amorphous metal. Amorphous metal is an amorphous magnetic material produced by rapidly cooling a molten metal in which iron (Fe), boron (B), silicon (Si), etc., are mixed. But, it is of course noted that the amorphous metal is limited thereto.

The coil 200 can be wound in a Y type around the first leg 110a, the second leg 110b, and the third leg 110c. The coil 200 includes a first winding 210, a second winding 220, and a third winding 230. The coil 200 can be wound in a zig-zag fashion around the first leg 110a, the second leg 110b, and the third leg 110c to reduce harmonics and unbalance of voltage and current generated from the power distribution system.

The zig-zag winding of the coil 200 means that the first winding 210, the second winding 220 and the third winding 230 constituting the coil 200 are wound in a crossing manner around two or more legs selected from the group consisting of the first leg 110a, the second leg 110b and the third leg 110c of the core 110. Alternatively, the zig-zag winding of the coil 200 may mean that two or more windings selected from the group consisting of the first winding 210, the second winding 220 and the third winding 230 of the coil 200 are wound in a crossing manner around the first leg 110a, the second leg 110b and the third leg 110c of the core 110, respectively.

For example, referring to FIG. 3, the power quality improvement device 10 according to one embodiment of the present invention is constructed such that the first winding 210 of the coil 200 is wound around the first leg 110a and the third 110c in the order of the first leg 110a, the third leg 110c, the first leg 110a, the third leg 110c and the first leg 110a, and the second winding 220 of the coil 200 is wound around the second leg 110b and the first 110a in the order of the second leg 110b, the first leg 110a, the second leg 110b, the first leg 110a and the second leg 110b. Also, the third winding 230 of coil 200 is wound around the third leg 110c and the second leg 110b in the order of the third leg 110c, the second leg 110b, the third leg 110c, the second leg 110b and the third leg 110c. In this case, the first winding 210, the second winding 220 and the third winding 230 are constructed to be connected to a neutral wire N, respectively.

In the meantime, the first winding 210 of the coil 200 may be wound in an opposite direction to the winding order around the first leg 110a and the third leg 110c, and the second winding 220 may be wound in an opposite direction to the winding order around the second leg 110b and the first leg 110a. In addition, the third winding 230 may be wound in an opposite direction to the winding order around the third leg 110c and the first leg 110a. Then, the magnitudes of the magnetic fluxes on the respective legs 110a, 110b and 110c are the same, but the phases of zero-phase sequence current generated from loads are opposite to each other so that the magnetic flux is cancelled, and thus harmonics and current of an unbalanced component are reduced.

The turn ratios of the first winding 210, the second winding 220 and the third winding 230 of the coil 200, which are wound in a zig-zag fashion around the first leg 110a, the second leg 110b and the third leg 110c, may be 1:1:1:1:1 or 1:2:2:2:1, respectively. That is, for example, the turn ratio of the first winding 210 wound in a zig-zag fashion around the first leg 110a and the third 110c in the order of the first leg 110a, the third leg 110c, the first leg 110a, the third leg 110c and the first leg 110a may be 1:1:1:1:1 or 1:2:2:2:1. But, the turn ratio of the first winding 210 is not limited thereto, and it is obvious that the first winding 210 can be wound in various turn ratios within a range which can be implemented by a person of ordinary skill in the art to which the present invention pertains.

Now, the physical structure of the power quality improvement device according to one embodiment of the present invention will be described hereinafter in detail with reference to FIGS. 3 to 5.

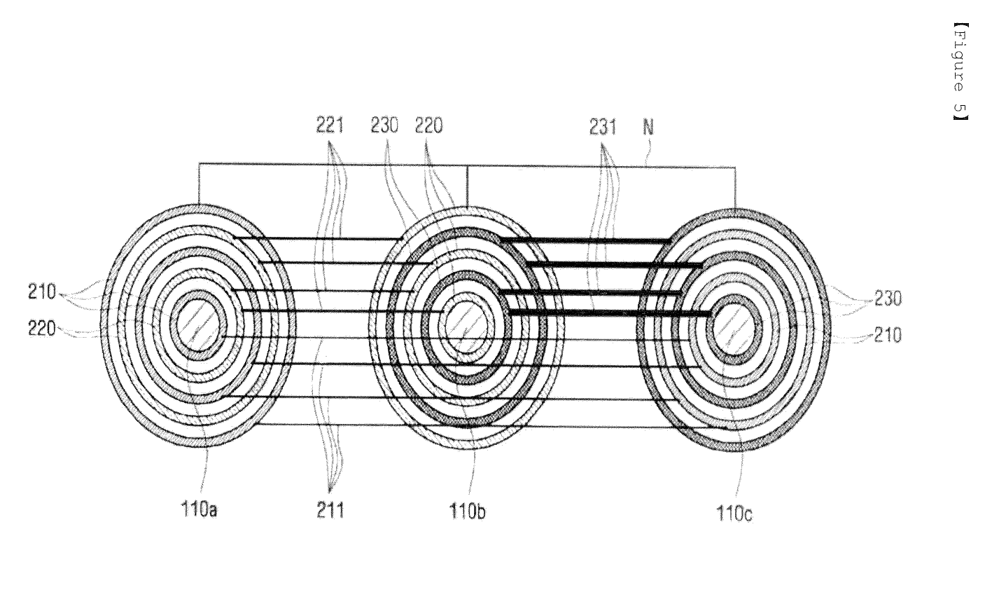

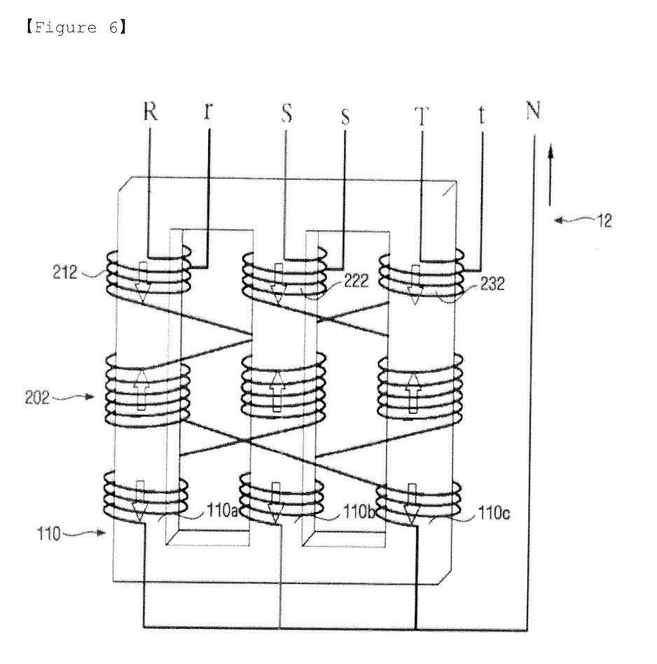

FIG. 4 is a perspective view illustrating a power quality improvement device according to one embodiment of the present invention, and FIG. 5 is a top plan view of the power quality improvement device shown in FIG. 4.

Referring to FIGS. 3 to 5, the power quality improvement device 10 according to one embodiment of the present invention is constructed such that the first winding 210, the second winding 220 and the third winding 230 of the coil 200 are wound in a zig-zag fashion around the first leg 110a, the second leg 110b and the third leg 110c of the core 110 as described above. In this case, two types of windings selected from the group consisting of the first winding 2100, the second winding 220 and the third winding 230 of the coil 200 are wound alternately around the first leg 110a, the second leg 110b and the third leg 110c, respectively. That is, the two types of windings wound around the first leg 110a, the second leg 110b and the third leg 110c, respectively, may be wound in an overlapping manner around the core 110 in the winding order.

Herein, the winding of the two types of windings in an overlapping manner around the core 110 means that the two types of windings are wound overlappingly on a plane perpendicular to an axis of any one of the first leg 110a, the second leg 110b and the third leg 110c as shown in FIGS. 4 and 5. In other words, it has been shown in FIG. 3 that the first winding 210, the second winding 220 and the third winding 230 of the coil 200 are wound at different positions on the first leg 110a, the second leg 110b and the third leg 110c in order to describe a winding method. However, the power quality improvement device 10 according to one embodiment of the present invention is actually constructed such that the first winding 210, the second winding 220 and the third winding 230 of the coil 200 are wound in an overlapping manner around the respective legs 110a, 110b, and 110c in the winding order as shown in FIGS. 4 and 5.

In this case, two types of windings selected from the group consisting of the first winding 2100, the second winding 220 and the third winding 230 of the coil 200 can be wound alternately around each of the first leg 110a, the second leg 110b and the third leg 110c. A winding, which is first wound around each of the first leg 110a, the second leg 110b and the third leg 110c, can be wound around each leg while abutting against each leg. In addition, the two types of windings wound alternately around each of the first leg, the second leg and the third leg can be wound such that there is an increase in a separation distance between the windings and each leg 110a, 110b or 110c around which the two types of windings are wound in the winding order.

More specifically, the first winding 210, the second winding 220, the first winding 210, the second winding 220 and the first winding 210 are sequentially wound in an overlapping manner around the first leg 110a. In this case, the wound windings are wound so as to be insulated from each other. That is, the first winding 210, the second winding 220, the first winding 210, the second winding 220 and the first winding 210 sequentially wound around the first leg 110a are formed in such a fashion as to be spaced apart from each other at predetermined intervals such that they are insulated from each other.

The second winding 220, the third winding 230, the second winding 220, the third winding 230 and the second winding 220 are sequentially wound in an overlapping manner around the second leg 110b. In this case, the wound windings are wound so as to be insulated from each other. That is, the second winding 220, the third winding 230, the second winding 220, the third winding 230 and the second winding 220 sequentially wound around the second leg 110b are formed in such a fashion as to be spaced apart from each other at predetermined intervals such that they are insulated from each other. In this case, a second winding 120b of the primary coil 120 can be wound around the second winding 220 positioned at the outermost shell of the second leg.

The third winding 230, the first winding 210, the third winding 230, the first winding 210 and the third winding 230 are sequentially wound in an overlapping manner around the third leg 110c. In this case, the wound windings are wound so as to be insulated from each other. That is, the third winding 230, the first winding 210, the third winding 230, the first winding 210 and the third winding 230 sequentially wound around the third leg 110c are formed in such a fashion as to be spaced apart from each other at predetermined intervals such that they are insulated from each other.

In the meantime, the power quality improvement device 10 according to one embodiment of the present invention may be a transformer manufactured in an insulation manner selected from the group consisting of a dry type, a mold type, an oil-filled type and a gas type, but is not limited thereto. More specifically, the dry type transformer is a transformer that is used without being immersed in insulation oil and is insulated by exposing a main body of the transformer to the atmosphere instead of the insulation oil and cooling it. The mold type transformer is a transformer that is molded with epoxy resin as a fire retardant. The oil-filled type transformer is a transformer that uses insulation oil as an insulation medium. In addition, the gas type transformer is a transformer that uses gas such as SF6 as an insulation medium. That is, the power quality improvement device 10 according to one embodiment of the present invention 10 may adopt any insulation type if the overlappingly wound windings can be formed so as to be insulated and spaced apart from each other in the winding order. It is of course to be noted that the present invention can include various insulation manners besides the above-mentioned insulation manners within a range which can be implemented by a person of ordinary skill in the art to which the present invention pertains.

In the meantime, the first winding 210 of the coil 200 is wound in a zig-zag fashion around the first leg 110a and the third leg 110c in the order of the first leg 110a, the third leg 110c, the first leg 110a, the third leg 110c and the first leg 110a. In this case, the wound windings that are insulated from each other and spaced apart from each other are connected by a first connecting wire 211 in order to implement the power quality improvement device 10 in which the windings are wound in an overlapping manner as shown in FIGS. 4 and 5.

In other words, the first winding 210 is separately wound around the first leg 110a and the third leg 110c, respectively, and the first windings 210 divided into a plurality of sections are connected to each other by the first connecting wire 211 so as to interconnect the first windings 210 wound around the first leg 110a and the third leg 110c.

Similarly, the second winding 220 is separately wound around the first leg 110a and the second leg 110b, respectively, and the second windings 220 divided into a plurality of sections are connected to each other by a second connecting wire 221 so as to interconnect the second windings 220 wound around the first leg 110a and the second leg 110b.

The third winding 230 is separately wound around the second leg 110b and the third leg 110c, respectively, and the third windings 230 divided into a plurality of sections are connected to each other by a third connecting wire 231 so as to interconnect the third windings 230 wound around the second leg 110b and the third leg 110c.

In FIG. 5, the first connecting wire 211, the second connecting wire 221 and the third connecting wire 231 are indicated by lines with different thicknesses for the sake of distinction, but are not limited thereto. That is, the first connecting wire 211, the second connecting wire 221 and the third connecting wire 231 may be the same as each other or different from each other in terms of their thickness. Alternatively, the first connecting wire 211, the second connecting wire 221 and the third connecting wire 231 may be configured with the same lines as those of the first winding 210, the second winding 220 and the third winding 230.

According to the power quality improvement device according to one embodiment of the present invention, a plurality of windings is wound in an overlapping manner around each of the first leg 110a, the second leg 110b and the third leg 110c.

In general, when a plurality of windings is wound around one leg in the transformer, they are wound at different positions of the leg, respectively. More specifically, the plurality of windings is wound juxtaposedly in an axial direction of the leg. For example, windings are wound around three legs according to the pattern of the conceptual view of FIG. 3 or 5. In such a construction, since a separation distance is required to be secured between the plurality of windings wound juxtaposedly around the leg, a necessary space and volume is significantly increased. In addition, a winding method is complicated in which the windings are wound in a zig-zag fashion, and the transformer is difficult to manufacture, which contributes to an increase in the manufacturing cost. In the meantime, there is involved a problem in that the volume of the transformer increases and the winding method is complicated, leading to an increase in leakage current.

According to the power quality improvement device according to one embodiment of the present invention, a plurality of windings is wound overlappingly on a plane perpendicular to an axis direction of each of the first leg 110a, the second leg 110b and the third leg 110c. That is, since the plurality of windings is wound overlappingly around an axis of each of the legs 110a, 110b and 110c, the demanded length of each of the leg 110a, 110b and 110c is remarkably shortened. Thus, the volume of the transformer can be greatly reduced.

In addition, according to the power quality improvement device according to one embodiment of the present invention, the zig-zag winding method is easily performed. More specifically, referring to FIGS. 4 and 5, since the first winding 210, the second winding 220 and the third winding 230 wound overlappingly around the first leg 110a, the second leg 110b and the third leg 110c are connected to each other by the first connecting wire 211, the second connecting wire 221 and the third connecting wire 231, the winding method becomes significantly simple. Thus, the time and cost required to perform the manufacture process can be greatly saved, resulting in an increase in a manufacturing cost saving effect.

Moreover, according to the power quality improvement device according to one embodiment of the present invention, since the windings are wound efficiently at less volume, the efficiency of the power quality improvement device formed of an autotransformer increases. That is, since the power quality improvement device is implemented in a more efficient structure and method, it is possible to provide a power quality improvement device which is considerably excellent in both a harmonics reduction function and a current unbalance cancellation function while maintaining a transformer performance.

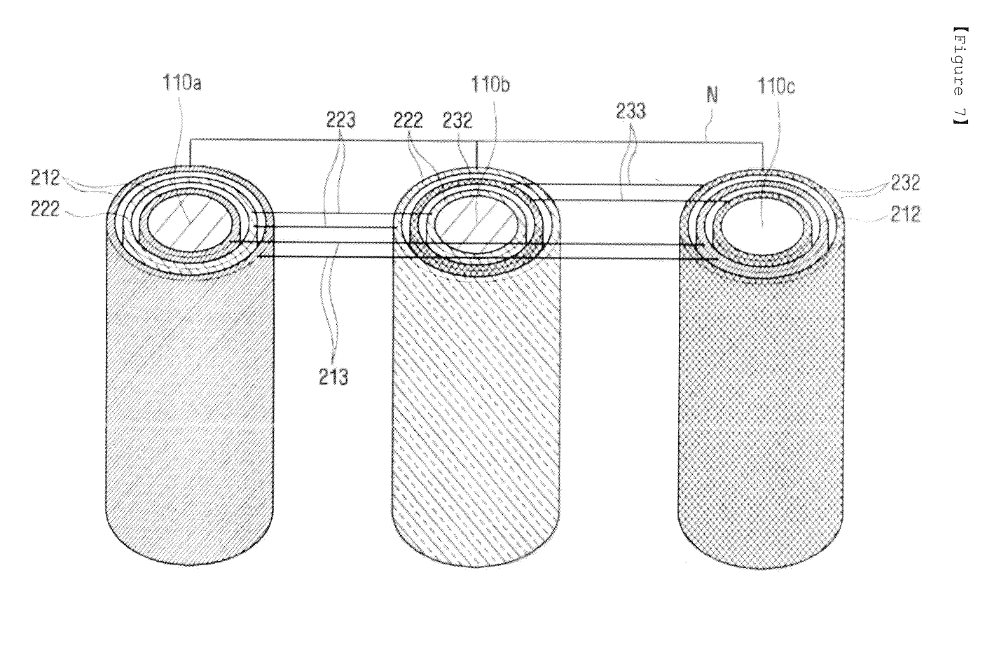

A power quality improvement device according to another embodiment of the present invention will be described hereinafter with reference to FIGS. 6 to 9

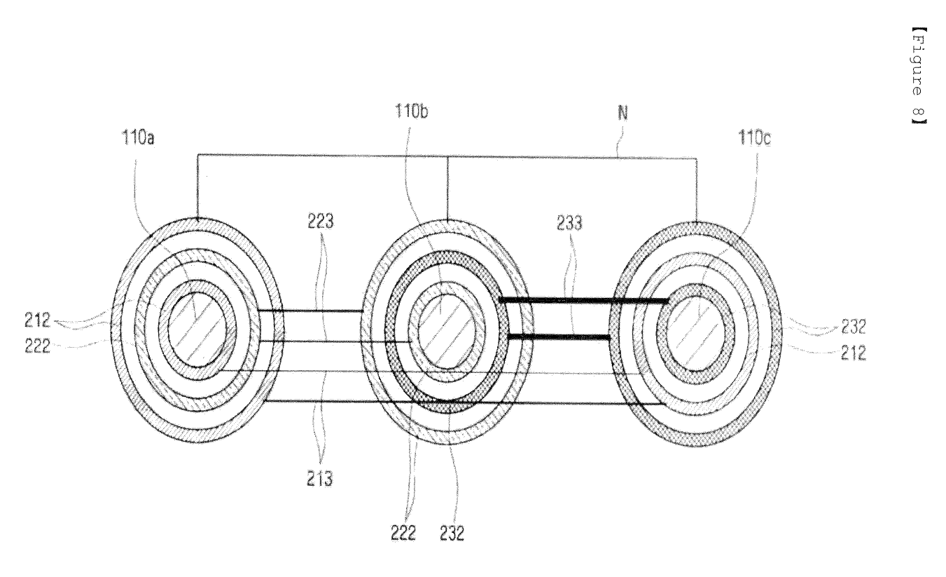

FIG. 6 is a conceptual view illustrating a power quality improvement device according to another embodiment of the present invention, FIG. 7 is a perspective view illustrating a power quality improvement device according to another embodiment of the present invention, and FIG. 8 is a top plan view of the power quality improvement device shown in FIG. 7.

Referring to FIGS. 6 to 8, the power quality improvement device according to another embodiment of the present invention is different from the power quality improvement device according to one embodiment of the present invention in terms of the number of zig-zag windings. In the power quality improvement device according to another embodiment of the present invention, a detailed description of the same contents as those of the power quality improvement device according to one embodiment of the present invention will be omitted to avoid redundancy.

In the power quality improvement device 20 according to another embodiment of the present invention, a first winding 212 of a secondary coil 202 is wound in a zig-zag fashion around the first leg 112a and the third leg 112b in the order of the first leg 112a, the third leg 112b and the first leg 112. A second winding 222 of the secondary coil 202 is wound in a zig-zag fashion around the second leg 112b and the first leg 112a in the order of the second leg 112b, the first leg 112a and the second leg 112b. Also, a third winding 232 of the secondary coil 202 is wound in a zig-zag fashion around the third leg 112c and the second leg 112b in the order of the third leg 112c, the second leg 112b and the third leg 112c. In this case, the windings wound sequentially around each of the legs 112a, 112b and 112c are wound in an overlapping manner so as to be insulated from each other and spaced apart from each other is the same as in the power quality improvement device according to one embodiment of the present invention.

Meanwhile, the first winding 212, the second winding 222 and the third winding 232 separately formed on different legs 112a, 112b and 112c are connected to each other by a first connecting wire 213, a second connecting wire 223 and the third connecting wire 233.

While the embodiments of the present invention have been described in connection with the exemplary embodiments illustrated in the drawings, they are merely illustrative embodiments and the invention is not limited to these embodiments. It is to be understood that various other equivalent modifications and variations of the embodiments can be made by a person of ordinary skill in the art without departing from the spirit and scope of the present invention.

That is, the embodiments of the present invention described herein are merely illustrative, and both the power quality improvement device and the power supply system which can be derived with the overall purport of the specification may be included in the scope of the present invention. It is natural that other than the power quality improvement device and the power supply system of the illustratively described structure, a transformer and system of the type in which the main features of the present invent can be implemented is included in the scope of the present invention. Therefore, both the power quality improvement device and the power supply system, which include a structure in which the windings are wound overlappingly on a plane perpendicular to an axis of each of the legs constituting the core, i.e., a structure in which a plurality of windings is wound overlappingly around the core, can be all included in the scope of the present invention. In the zig-zag transformers, a transformer including a structure in which a plurality of windings is wound in an overlapping manner around the legs may be included in the scope of the present invention irrespective of the order, method and number of zig-zag windings. In addition, a transformer including a structure in which a plurality of windings is wound in an overlapping manner around the core may be included in the scope of the present invention irrespective of an insulation method, a construction material, a winding method.

### INDUSTRIAL APPLICABILITY

The power quality improvement device having an improved function of harmonics and current unbalance, and the power supply system including the same according to the embodiments of the present invention can be applied to all the systems and structures of a technical field that is aimed at improving harmonics and current unbalance. In addition, the present invention can be applied to all the technical fields in which harmonics reduction and current unbalance improvement is required.

1. A power quality improvement device provided in the form of an autotransformer, the device comprising: an iron core comprising a first leg, a second leg, and a third leg; and a coil comprising a first winding, a second winding, and a third winding, which are wound in a zigzag fashion around the first leg, the second leg and the third leg, wherein at least two windings selected from the group consisting of the first, second and third windings are wound alternately around each of the first, second and third legs of the coil in such a fashion as to be wound overlappingly around the core in the winding order.

2. The power quality improvement device according to claim 1, wherein the two types of windings wound alternately around each of the first leg, the second leg and the third leg are wound such that there is an increase in a separation distance between the windings and each leg around which the two types of windings are wound in the winding order.

3. The power quality improvement device according to claim 2, wherein a winding, which is first wound around each of the first leg, the second leg and the third leg, is wound around each leg while abutting against each leg.

4. The power quality improvement device according to claim 1, wherein the two types of windings wound alternately around each of the first leg, the second leg and the third leg are wound overlappingly on a plane perpendicular to an axis of each leg in the winding order.

5. The power quality improvement device according to claim 1, wherein the first winding, the second winding and the first winding are sequentially wound in an overlapping manner around the first leg, the second winding, the third winding and the second winding are sequentially wound in an overlapping manner around the second leg, and the third winding, the first winding and the third winding are sequentially wound in an overlapping manner around the third leg.

6. The power quality improvement device according to claim 1, wherein the first winding, the second winding, the first winding, the second winding and the first winding are sequentially wound in an overlapping manner around the first leg, the second winding, the third winding, the second winding, the third winding and the second winding are sequentially wound in an overlapping manner around the second leg, and the third winding, the first winding, the third winding, the first winding and the third winding are sequentially wound in an overlapping manner around the third leg.

7. The power quality improvement device according to claim 1, wherein the first winding is wound around the first leg and the third leg in the order of the first leg, the third leg and the first leg, the second winding is wound around the second leg and the first leg in the order of the second leg, the first leg and the second leg, and the third winding is wound around the third leg and the second leg in the order of the third leg, the second leg and the third leg.

8. The power quality improvement device according to claim 1, wherein the first winding is wound around the first leg and the third leg in the order of the first leg, the third leg, the first leg, the third leg and the first leg, the second winding is wound around the second leg and the first leg in the order of the second leg, the first leg, the second leg, the first leg and the second leg, and the third winding is wound around the third leg and the second leg in the order of the third leg, the second leg, the third leg, the second leg and the third leg.

9. The power quality improvement device according to claim 1, wherein the autotransformer is manufactured in an insulation manner selected from the group consisting of a dry type, a mold type, an oil-filled type and a gas type.

10. A power quality improvement device provided in the form of an autotransformer, the device comprising: an iron core comprising a first leg, a second leg, and a third leg; and a coil comprising a first winding, a second winding, and a third winding, wherein the first winding is wound around the first leg and the third leg in the order of the first leg, the third leg, the first leg, the third leg and the first leg so as to be connected to a neutral wire, the second winding is wound around the second leg and the first leg in the order of the second leg, the first leg, the second leg, the first leg and the second leg so as to be connected to the neutral wire, and the third winding is wound around the third leg and the second leg in the order of the third leg, the second leg, the third leg, the second leg and the third leg so as to be connected to the neutral wire, whereby the first winding, the second winding, the first winding, the second winding and the first winding are sequentially wound in an overlapping manner around the first leg, the second winding, the third winding, the second winding, the third winding and the second winding are sequentially wound in an overlapping manner around the second leg, and the third winding, the first winding, the third winding, the first winding and the third winding are sequentially wound in an overlapping manner around the third leg.

11. The power quality improvement device according to claim 10, wherein a plurality of windings wound in an overlapping manner around each of the legs is wound overlappingly on a plane perpendicular to an axis of each leg, and is wound such that there is an increase in a separation distance between the windings and each leg around which the windings are wound in the winding order.

12. A power supply system comprising the power quality improvement device according to claim 11, wherein the power quality improvement device is connected in series between a load and a power supply for supplying power to the load.

13. The power supply system according to claim 12, wherein power quality improvement device is connected in series between a power receiving terminal and a power distribution terminal.

14. A power supply system comprising: a load; a power supply for supplying power to the load; a power quality improvement device connected in series between the load and the power supply and provided in the form of an autotransformer, wherein the power quality improvement device comprises: an iron core comprising a first leg, a second leg, and a third leg; and a coil comprising a first winding, a second winding, and a third winding, and wherein the first winding is wound around the first leg and the third leg in the order of the first leg, the third leg, the first leg, the third leg and the first leg so as to be connected to a neutral wire, the second winding is wound around the second leg and the first leg in the order of the second leg, the first leg, the second leg, the first leg and the second leg so as to be connected to the neutral wire, and the third winding is wound around the third leg and the second leg in the order of the third leg, the second leg, the third leg, the second leg and the third leg so as to be connected to the neutral wire.

15. A power supply system comprising the power quality improvement device according to claim 10, wherein the power quality improvement device is connected in series between a load and a power supply for supplying power to the load.

16. A power supply system comprising the power quality improvement device according to claim 9, wherein the power quality improvement device is connected in series between a load and a power supply for supplying power to the load.

17. A power supply system comprising the power quality improvement device according to claim 6, wherein the power quality improvement device is connected in series between a load and a power supply for supplying power to the load.

18. A power supply system comprising the power quality improvement device according to claim 3, wherein the power quality improvement device is connected in series between a load and a power supply for supplying power to the load.

19. A power supply system comprising the power quality improvement device according to claim 2, wherein the power quality improvement device is connected in series between a load and a power supply for supplying power to the load.

20. A power supply system comprising the power quality improvement device according to claim 1, wherein the power quality improvement device is connected in series between a load and a power supply for supplying power to the load.
